(19) United States
(12) Patent Application Publication
(10) Pub. No.: US 2005/0135633 A1
(43) Pub. Date: Jun. 23, 2005

(54) Audio system

(76) Inventor: George Thames Denmark JR., Leucadia, CA (US)

Correspondence Address: JACKIE JAY SCHWARTZ, 1350 Broadway, Suite 1510, NEW YORK, NY, 10018, US

(21) Appl. No.: 10/850,658

(22) Filed: May 21, 2004

Related U.S. Application Data
(60) Provisional application No. 60/531,298, filed on Dec. 19, 2003.

(51) Int. Cl. H04B 3/00; H04R 1/02

(52) U.S. Cl. 381/77; 381/333; 381/388

(57) ABSTRACT

An audio capture and transmission system for use during aquatic activity includes means for capturing sound associated with an aquatic activity. The system also includes a harness for securing the system to a user. The harness houses the capturing means and includes means for protecting the capturing means from the aquatic environment. Means for transmitting a signal representative of the captured sound is connected to the capturing means. The transmitted signal is able to be received and combined with a corresponding video signal.

### CROSS-REFERENCE TO RELATED APPLICATIONS

This application claims priority through U.S. Provisional Application 60/531,298 filed Dec. 19, 2003 for an “Audio System for Use During Surfing.”

### BACKGROUND OF THE INVENTION

1. Field of the Invention

The present invention relates generally to audio systems and, more specifically, to a system for capturing ambient sound and verbal communication while surfing. Upon capturing the sound, the apparatus transmits audio signals representing the captured sounds for receipt by a remote unit. The remote unit is able to receive and reproduce the audio signals. The audio signals may be output to local speakers connected to the remote unit. Also, the remote unit is able to distribute the audio signals across at least one of a telecommunications, cable and satellite network for use in audio-visual broadcasting of surfing competitions.

2. Description of the Prior Art

Numerous types of audio capture and transmission systems exist in the prior art. Many sporting events include portable microphones which are affixed to players in order to capture any sound related to the participation in the sport. Examples of these can be seen in football whereby a microphone is attached to a player and is able to capture any sound which occurs during his play on the field. These sounds may include verbal discussion between players as well as the ambient sound of the players on the football field. Another example of these systems is found in auto-racing whereby microphones and transmitter devices are affixed to a driver and are able to transmit voice data and ambient audio sounds.

In both of the above described examples, the data is able to be transmitted from an individual player/participant so that spectators either in the stands or those watching a broadcast of the event are able to actively listen to what is occurring during the event. This allows the people watching the event to feel closer to the action and provides insight as to what it is like to be a player/participant.

However, while systems like this exist for the above described sports, no such systems are available to capture the sounds of surfers while they are surfing in the ocean. The prior art systems are not able be fully immersed in water, nor are they resilient enough to handle the stress caused by the waves of the ocean. While these systems may be suitable for the purposes for which they were designed, they would not be as suitable for the purposes of the present invention, as hereinafter described.

### SUMMARY OF THE PRESENT INVENTION

The present invention relates generally to audio systems and, more specifically, to a system for capturing ambient sound and verbal communication while surfing. Upon capturing the sound, the apparatus transmits audio signals representing the captured sounds for receipt by a remote unit. The remote unit is able to receive and reproduce the audio signals. The audio signals may be output to local speakers connected to the remote unit. Also, the remote unit is able to distribute the audio signals across at least one of a telecommunications, cable and satellite network for use in audio-visual broadcasting of surfing competitions.

A primary object of the present invention is to provide an audio system which overcomes the shortcomings of the prior art.

Another secondary object of the present invention is to provide an audio system including a wearable harness having a microphone for capturing at least one of ambient sound and audible conversation. The present invention further includes a transmitter for transmitting the captured audio signals to a remote unit for reproduction thereof.

A further object of the present invention is to provide an audio system wherein the microphone and transmitter are contained within a housing for protection thereof. The housing is preferably formed from a dense plastic material that is waterproof for preventing damage to each of the microphone and the transmitter contained therein. Furthermore, the housing should be able to withstand extreme pressures associated with wave force as well as direct impact on the water's surface or on the surfboard.

Another object of the present invention is to provide a garment for use with the present an audio system. The garment preferably is worn on the torso of a surfer and includes a pocket for receiving the housing of the system therein. The garment also includes a microphone patch positioned thereon for retaining an external microphone therein. The garment aide in providing protection for each of the external microphone and the housing while allowing the system to fully capture all ambient sounds associated with surfing.

Yet another object of the present invention is to provide an audio system including the remote unit for receiving signals representing at least one of ambient sound and audible conversation from the transmitter. The remote unit includes an output device for outputting the audible sound signals.

An even further object of the present invention is to provide an audio system wherein the output device includes at least one of speakers connected to the remote unit and means for distributing the audio signals over a network. Preferably the audio signals are broadcast over a television network. However, the distributing means may distribute the audio signals over at least one of a cable network, satellite network, a communications network and the Internet.

Yet another object of the present invention is to provide an audio system including a transceiver within the housing as well as a microphone and a speaker connected thereto for selectively transmitting and receiving audio signals from a mobile unit. Preferably, the mobile until is positioned on or made integral with a mobile aquatic craft such as a jet ski. The user wearing the audio system is able to selectively communicate via the microphone to a second person driving the mobile aquatic craft. This is particularly useful when the mobile aquatic craft is towing a user on a surfboard through rough aquatic conditions.

Another object of the present invention is to provide an audio system that is preferably used during surfing. However, the audio system may also be used during participation in any aquatic sports including but not limited to jet skiing, water-skiing, wake-boarding, parasailing, wind-surfing, and swimming.

Still another object of the present invention is to provide an audio system that is simple and easy to use.

Still yet another object of the present invention is to provide an audio system that is inexpensive to manufacture and use.

Additional objects of the present invention will appear as the description proceeds.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is a perspective view of a surfer using the audio system of the present invention;

FIG. 2 is a block diagram of the audio system of the present invention;

FIG. 3 is an exploded view of the housing and harness of the audio system of the present invention;

FIG. 4 is front view of an alternate embodiment of the audio system of the present invention;

FIG. 5 is illustrative external view of a surfing shirt for use with the audio system of the present invention;

FIG. 6 is an illustrative internal view of a surfing shirt for use with the audio system of the present invention;

FIG. 7 is an illustrative view of the pocket of the surfing shirt a for use with the audio system of the present invention;

FIG. 8 is an illustrative view of the microphone patch positioned on the surfing shirt for use with the audio system of the present invention;

FIG. 9 is an illustrative view of a person inserting the audio system into the surfing garment;

FIG. 10 is an illustrative view of an alternate embodiment of the audio system of the present invention; and

FIG. 11 is a block diagram of the alternative embodiment of the audio system of the present invention.

### DETAILED DESCRIPTION OF THE PREFERRED EMBODIMENTS

The following discussion describes in detail one embodiment of the invention and several variations of that embodiment. This discussion should not be construed, however, as limiting the invention to those particular embodiments. Practitioners skilled in the art will recognize numerous other embodiments as well. For a definition of the complete scope of the invention, the reader is directed to the appended claims.

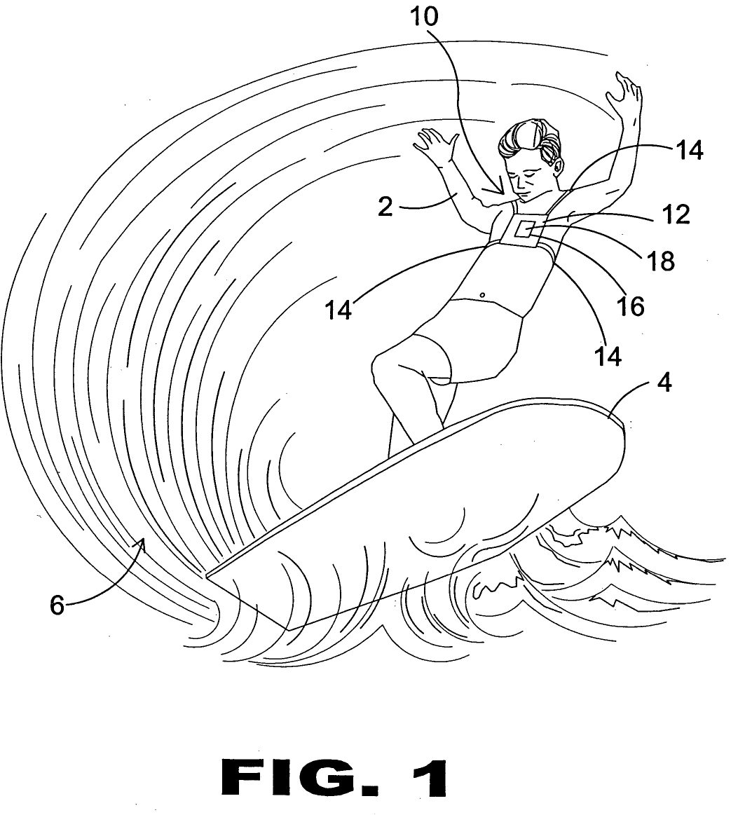

Turning now descriptively to the drawings, in which similar reference characters denote similar elements throughout the several views. FIGS. 1 through 11 illustrate the audio system, hereinafter known as “the system” of the present invention indicated generally by the numeral 10.

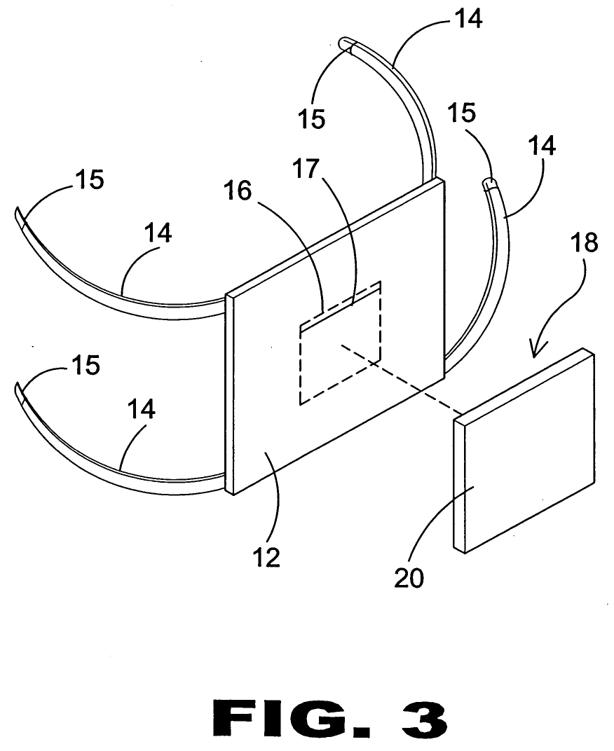

FIG. 1 is a perspective view of a surfer using the audio system of the present invention. A user 2 is shown standing on a surfboard 4 surfing a wave 6. The surfer 2 is wearing the system 10 of the present invention. The system 10 is secured to the surfer 2 by a harness 12 having straps 14 extending therefrom. The straps 14 are preferably positioned around the chest and shoulders of the surfer 2 and are secured by a securing device as shown in FIG. 3. However, any form of harness able to be securely attached to a user's body may be used. Preferably, the harness 12 is formed from a lightweight, breatheable and pliable material such as mesh or micromesh. It is important for the harness 12 to be formed from this material because mesh or micromesh allow the surfer 2 freedom of movement with minimal restriction as well as not absorbing an excess amount of water while the surfer 2 is surfing thereby weighing down the surfer 2 and altering the surfer's balance. While the harness is described as being formed from mesh material, the harness 12 may be formed from any material that is lightweight, breatheable and pliable. The harness 12 further includes a pocket 16 for securing a communication unit 18 therein.

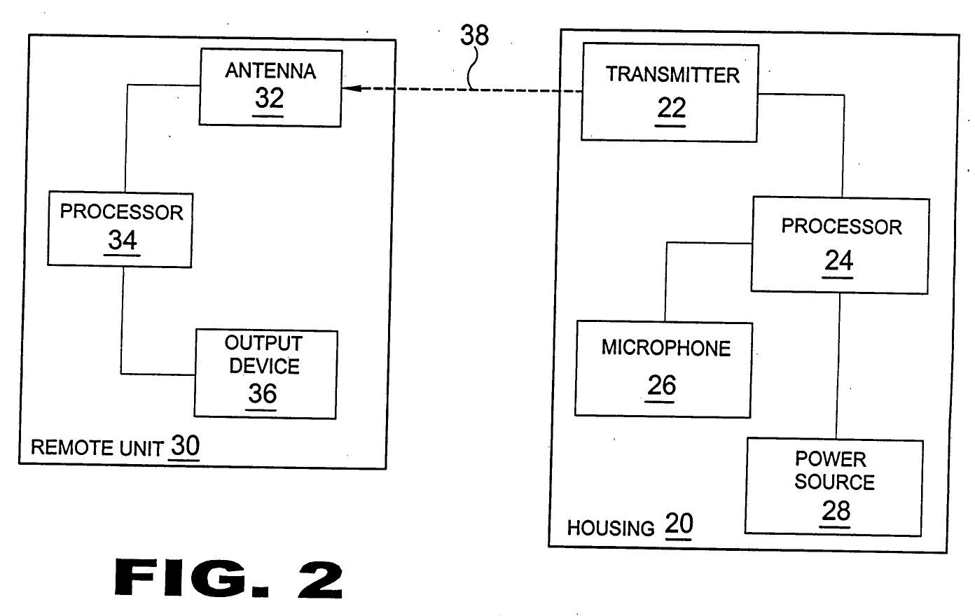

The communication unit 18 includes a housing 20. Positioned within the housing 20 is a microphone 26 and a transmitter 22 as is shown in FIG. 2. The microphone 26 is able to capture at least one of ambient sound and audible conversation occurring within a predetermined distance thereof. The function of the microphone 26 and transmitter 22 will be discussed hereinafter with specific reference to FIG. 2. The housing 20 is preferably formed from a hard plastic material that is waterproof. Ideally, the housing 20 is able to withstand the force exerted by at least one of crashing waves, direct impact with the surface of the water and direct impact with the surface of the surfboard 4. While, the housing 20 is described as being formed from hard plastic, the housing 20 may be formed from any material that is lightweight, hard and waterproof so that it may protect the components contained therein.

FIG. 2 is a block diagram of the audio system of the present invention. The system 10 includes the communication unit 18 and a remote unit 30 for receiving data therefrom. The communication unit 18 includes a first processor 24 and the transmitter 22 and microphone 26 connected to the first processor 24. A power source 28 is also connected to the first processor 24 and provides power to the communication unit 18. Preferably, the power source 28 is a rechargeable power source that can be quickly recharged for multiple uses thereof. The remote unit 30 includes a second processor 34 and an antenna 32 and output device 36 connected thereto. The output device 36 is at least one of speakers, a means for distributing audio signals and a means for broadcasting audio signals. Preferably, the means for broadcasting audio signals is able to broadcast the signals over at least one of a television network, cable and satellite network. Also, it is preferable that the means for distributing audio signals is able to distribute those signals over at least one of a telecommunications network and the Internet. The transmitter 22 is able to transmit an audio signal as indicated by reference numeral 38 for receipt by the antenna 32. Preferably, the audio signal 38 includes but is not limited to data representing ambient sound captured during surfing and verbal communication from the surfer captured by the microphone 26. Additionally, the transmitter 22 is able to transmit at least one of analog and digital data to the remote unit 30. The antenna 32 is able to selectively receive at least one of analog and digital data signals received thereby.

FIG. 3 an exploded view of the housing and harness of the audio system of the present invention. The harness 12 includes a plurality of straps 14 for securing the harness 12 to a body of a surfer. Preferably, the harness 12 is secured to the back of the surfer. Each of the plurality of straps 14 includes a fastening device 15 positioned at an end thereof. When the harness 12 is secured to the surfer, the fastening devices contact each other and fasten the straps together thereby securing the harness 12 to the surfer. Preferably, the fastening devices are snap fit clips. However, the fastening devices 15 may be formed from any fastening device able to withstand the force exerted by a large wave generally associated with surfing. The harness 12 includes the pocket 16. As shown in FIG. 3, the housing 20 of the transmitter unit 18 is selectively positionable within the pocket 16 of the harness. The transmitter unit 18 is secured within the pocket 16 by a locking device 17. Preferably, the locking device 17 is at least one of buttons and zipper. However, any method of locking contents within a pocket 16 may be used.

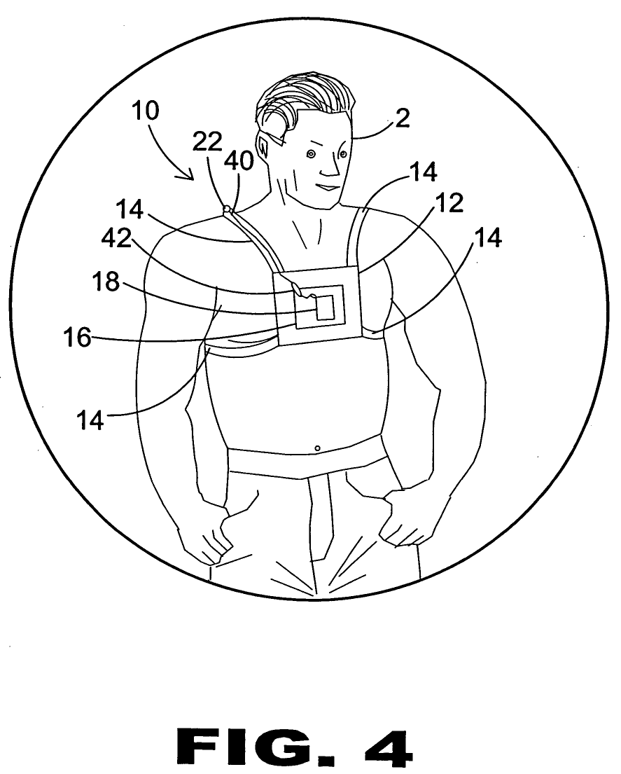

FIG. 4 is a front view of an alternate embodiment of the audio system of the present invention. The harness 12 including the communication unit 18 is secured to the back of a surfer 2. The communication unit 18 is positioned within the pocket 16. The harness 12 includes a shoulder mount 40 positioned on one strap 14. The shoulder mount 40 allows for selective mounting of a microphone 22 thereon. The microphone 22 is connected to the communication unit 18 via a connection cord 42. Preferably, the microphone 22 and the connection cord 42 are waterproof thereby allowing the audio signals captured by the microphone 22 to clearly pass through the connection cord 42 for transmission by the transmitter 26 which is shown in FIG. 2. By positioning the microphone 22 externally on the shoulder mount 40, the microphone is kept at a predetermined and desirable distance from the water and is thus able to capture at least one of ambient sound and audible conversation for transmission to and reproduction by the remote unit 30. Thereafter, the remote unit 30 is able to selectively broadcast the received audio data over at least one of a television network, cable network, and satellite network. The remote unit 30 is also able to selectively distribute the received data over at least one of a communication network and the Internet.

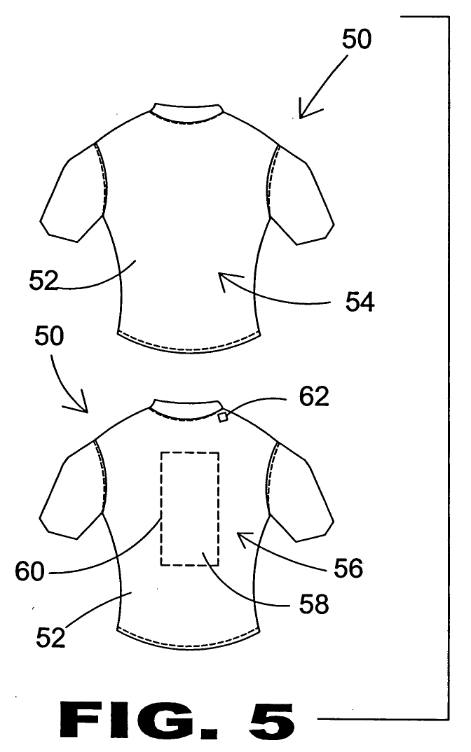

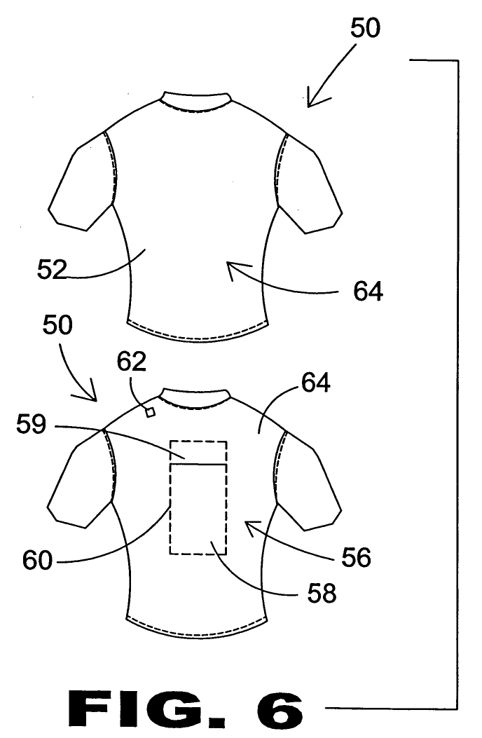

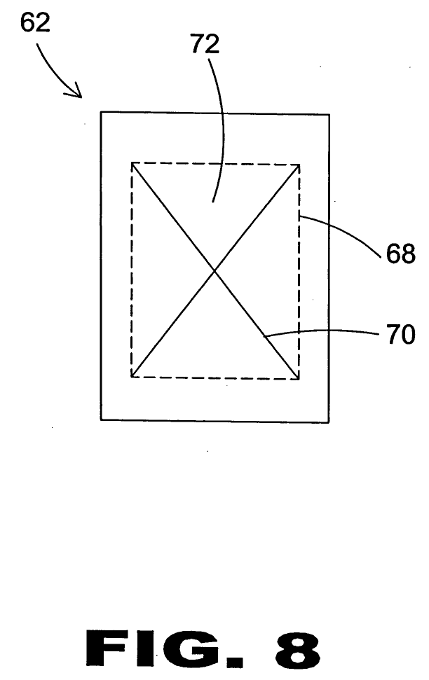

FIG. 5 is illustrative external view of a surfing shirt for use with the audio system of the present invention. Another embodiment for retaining the system 10 of the present invention is shown herein. A garment 50 which is preferably a shirt for use during surfing. The garment is described as being useful for surfing for purposes of example only. The garment 50 may be selectively used during the participation of any aquatic activity. The garment 50 has an external surface 52 shown herein and an internal surface 64 as shown and described hereinafter with specific reference to FIG. 6. The garment 50 includes a front side 54 and a rear side 56. The front side 54 has nothing positioned thereon in order to allow at least one of a competition identifier and advertising to be positioned thereon. The rear side 56 of the garment 50 shows stitching 60 which secures a pocket 58 to an interior surface 64 of the rear side 56 of the garment 50. The pocket 58 selectively retains the housing 20 of the system 10 therein, as shown in FIG. 6. Also positioned on the rear side 56 of the garment 50 is a microphone patch 62. Preferably the microphone patch 62 is positioned substantially where a shoulder meets the neck line of the garment 50. The microphone patch 62 could be selectively positioned by either the left or right shoulder of the garment. The microphone patch 62 will be discussed further hereinafter with specific reference to FIG. 8.

The garment 50 is preferably formed from lightweight material that does not absorb water. Additionally, the material must be durable and strong in order to maintain the housing 20 of the system 10 within the pocket 58 thereof. Also, the material used in forming the garment should not be easily stretched thereby preventing any deformation of the garment by the system 10 of the present invention. Ideally, the garment is formed from neoprene.

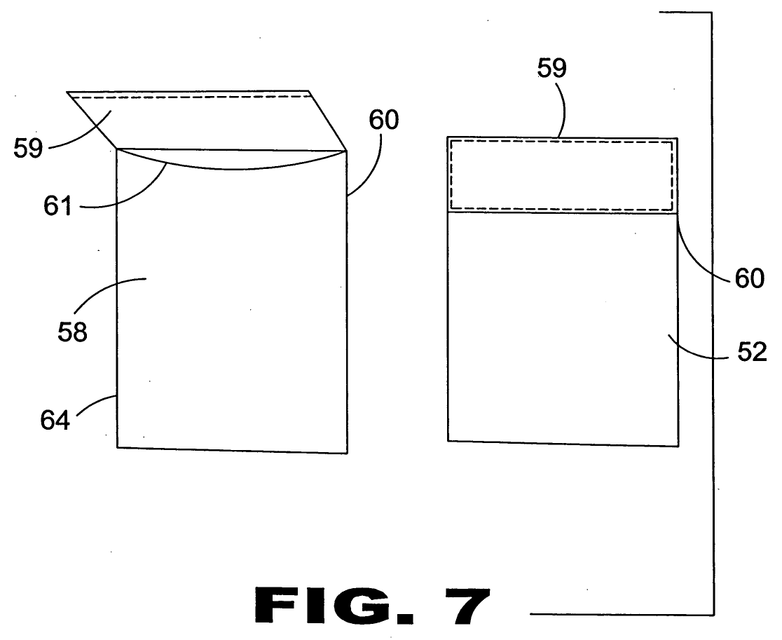

FIG. 6 is an illustrative internal view of a surfing shirt for use with the audio system of the present invention. As discussed above with respect to FIG. 5, the garment 50 includes the internal surface 64 having the front side 54 and the rear side 56. The rear side 56 of the internal surface 64 includes the pocket 58. Preferably the pocket has width of 150 mm and a height of 270 mm. However, the pocket 58 may be any size that is able to accommodate the housing 20 of the system 10 therein. The pocket 58 is secured to substantially the center of the rear side 56 of the garment by the stitching 60 which extends around the perimeter of thereof. The pocket 58 includes the flap 59 for covering an opening 61, as shown in FIG. 7, thereof and securing the housing 20 of the system therein. The flap 59 is secured by additional stitching 60 to the rear side 56 of the garment 50 thereby causing the opening 61 to appear as a slit.

The microphone patch 62 is also shown positioned at substantially the point where a shoulder section meets a neck section of the garment 50. The internal side of the microphone patch 62 allow the microphone to be secured thereunder. The manner in which the microphone is secured will be discussed hereinafter with specific reference to FIG. 8.

FIG. 7 is an illustrative view of the pocket of the surfing shirt for use with the audio system of the present invention. As shown herein, is an enlarged view of the internal and external sides of the pocket 58. The internal side 64 of the pocket 58 shows the flap 59 positioned at a first end thereof. The opening 61 is positioned immediately below the flap 59 and is able to receive the housing 20 of the system therein. Alternatively, the flap 59 is hingedly connected to the garment so as to pivot about an axis thereby covering the opening 61 of the pocket 58 and securing the housing 20 therein. The stitching 60 extends around the perimeter of the pocket 58 and the flap 59 so as to secure the pocket 58 to the rear side 56 of the garment 50. Also shown in FIG. 7 is a view of the external surface 52 of the pocket 58.

FIG. 8 is an illustrative view of the microphone patch positioned on the surfing shirt for use with the audio system of the present invention. An internal surface of the microphone patch 62 is shown in FIG. 8. The microphone patch 62 as shown in FIG. 8 is the actual size thereof. Stitching 68 extends in a square around the patch 62. X-shaped slits 70 extend through a portion of the patch 62 within the square stitching 68. The slits 70 form 4 triangular flaps 72 which pivot about the stitching 68. The flaps 72 are selectively pivotable and reveal a second layer (not shown). Preferably the flaps are stiff material that is able to return to their original position as shown in FIG. 8.

When securing the microphone within the microphone patch 62, the flaps 72 are selectively pivoted about the stitching 68. The microphone is positioned adjacent to the second layer. Thereafter the flaps 72 are released and return to their original position thereby securing the microphone against the second layer and within the patch 62. The second layer adds additional level of protection for the microphone by preventing water from directly coming in contact therewith. Because the flaps 72 are stiff material they keep the microphone securely in position in the flap. It is important to maintain the microphone and any connection wires in a constant position in order to maintain the integrity of the sounds being captured thereby. By minimizing the movement of the microphone the present invention eliminates errors caused by a faulty connection between the wires and the microphone.

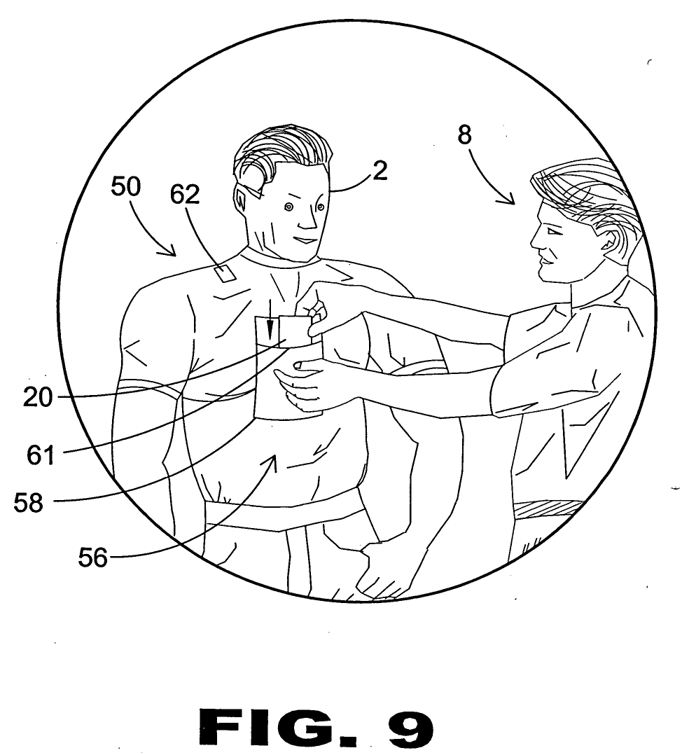

FIG. 9 is an illustrative view of a person inserting the audio system into the surfing garment. As shown herein a surfer 2 is wearing the surfing garment 50 as described hereinabove with specific reference to FIGS. 5-8. A second user 8 is shown assisting the surfer 2 in securing the housing 20 of the system therein. The second user selectively inserts the housing 20 into the opening 61 of the pocket 58 thereby securing the system therein. Upon securing the system therein, the external microphone connected to the housing 20 is secured under the patch 62. Once the microphone is secured in the patch 62, the surfer is able to paddle out and begin surfing. The system 10 of the present invention is able to selectively capture any ambient and/or conversational sound associated with surfing.

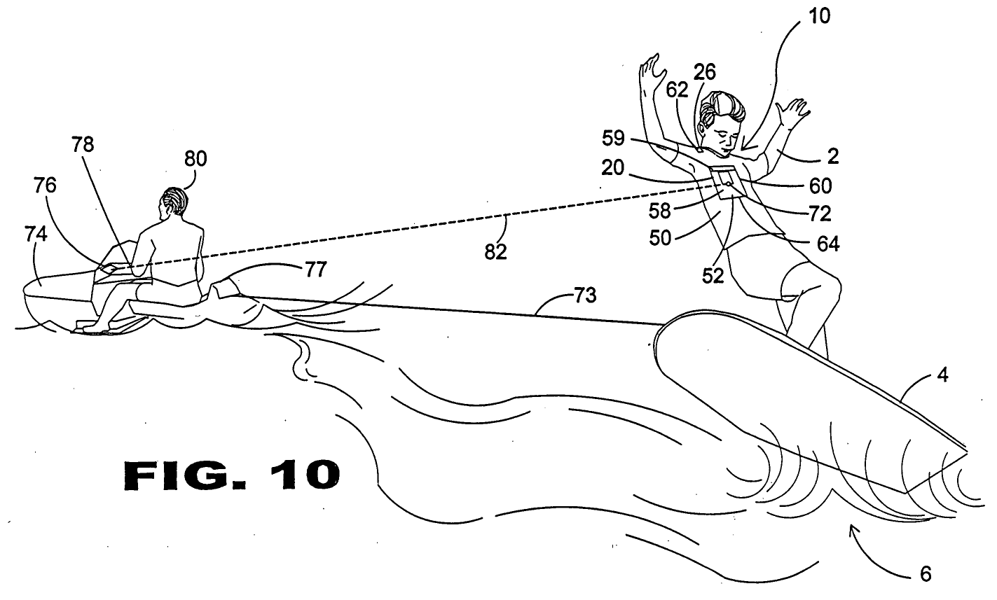

FIG. 10 is an alternate embodiment of the audio system 10 of the present invention. The embodiment as discussed hereinafter refers to an audio system that allows for two way communication. FIG. 10 shows the surfer 2 surfing on the surfboard 4 while being pulled along the water 6 by a mobile aquatic craft 74. The surfer 2 is wearing the garment 50 as described hereinabove with specific reference to FIGS. 5-9. Positioned within the pocket 60 of the garment is the housing 20 which retains the audio system 10 of the present invention therein. The housing 20 includes a speaker 72 positioned thereon for outputting sound received thereby. The garment 50 includes the patch 62 for retaining the microphone 26 therein. The microphone can selectively capture ambient and conversational audio sounds for transmission thereof.

The mobile aquatic craft 74 is shown in FIG. 10 towing the surfboard 4 via a tow-line 73. The craft, as depicted herein, is a jet ski being driven by a driver 78. However, the craft 74 may be any craft able to selectively move about in an aquatic environment. The craft 74 includes a mobile unit 76 which is connected to a headset 80 via a connection wire 77. The headset 80 includes listening means for listening to audible sounds output thereby and capturing means for capturing audible sounds for transmission thereof.

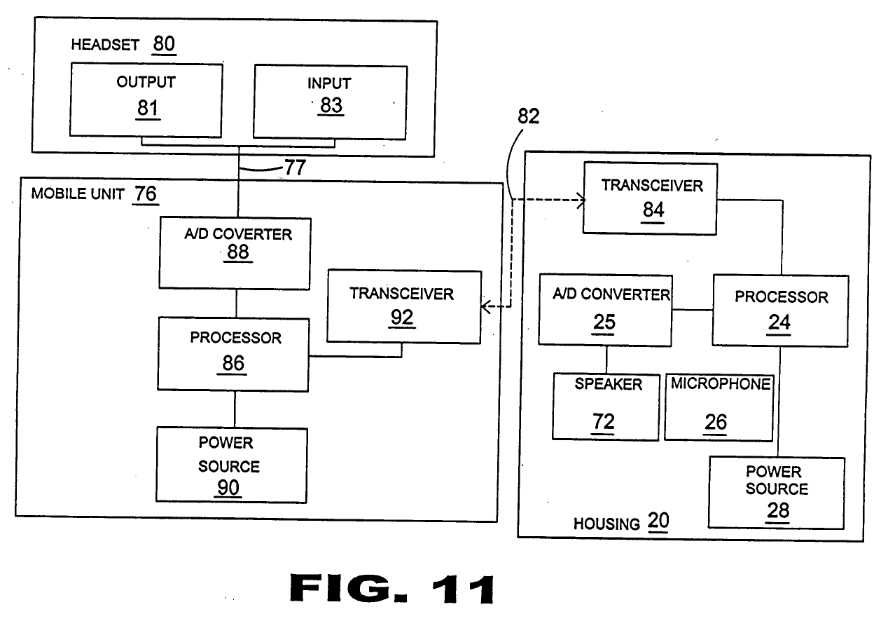

As shown in FIG. 10, the craft 74 is towing the surfer 2 on the surfboard 4. Each of the driver 78 and the surfer 2 can selectively communicate with each other. The driver 78 and surfer 2 can speak to one another using the headset 80 and the microphone 26 and speaker 72 respectively. The conversation between the driver 78 and the surfer 2 is transmitted as a signal 82 between the housing 20 and the mobile unit 76. This embodiment will be described in more detail hereinafter with specific reference to FIG. 11.

FIG. 11 is a block diagram of the alternate embodiment of the audio system of the present invention used as a two way communication device. The housing 20 includes the processor 24 being powered by the power source 28. The microphone 26 and the speaker 72 are connected to the processor through an analog-to-digital (A/D) converter 25. The speaker 72 as described herein is used as a general term for a device able to output audio data therefrom. A transceiver 84 for selectively transmitting and receiving data is also connected to the processor 24.

The mobile unit 76 also includes a second processor 86 that receives power from a power source 90. An analog-to digital converter 88 and a second transceiver 92 is connected to the processor 86. The headset 80 includes capturing means 83 and output means 81 which are both connected to the analog-to-digital converter 88 via the connection wire 77.

The operation of this embodiment of the audio system 10 as shown in FIGS. 10 and 11 will now be described. When the driver 78 desires to communicate with the surfer 2, the driver 78 speaks into the capturing means 83 of the headset 80. The processor directs the captured analog audio to be transmitted along the communication wire 77 wherein the signal is converted from analog to digital form by the second A/D converter 88. Thereafter the second processor 86 provides the digital data representing the captured audio sound to the second transceiver 92 which transmits the data as the signal represented by reference numeral 82. The first transceiver 84 positioned in the housing 20 receives the signal 82. The first processor 24 directs the transceiver 84 to provide the digital data signal 82 to the first A/D converter 25. Thereafter the processor 24 directs the A/D convert 25 to provide the analog signal to the speaker 72 for listening by the surfer 2.

The surfer 2 can selectively choose to respond to the driver 78. The surfer 2 speaks and the audible conversation is captured by the microphone 26. The first processor 24 directs the analog sound captured by the microphone 26 to be converted by the first A/D converter 25 and also directs the converted data to be provided to the transceiver 84 for transmission thereof. The signal 82 is transmitted by the first transceiver 84 for receipt by the second transceiver 92. The second processor 86 directs the second transceiver 92 to provide the received digital data 82 to the second A/D converter 88 for conversion into analog format. The converted signal is transmitted along the connection wire 77 to the headset 80 for output at the output means 81. Upon the signal being output, the driver 78 is able to hear what the surfer 2 is saying.

Alternatively, upon the signal 82 being received by either the first or second transceiver 84, 92, the processors 24, 86 can selectively provide the digital signals to each respective output 72, 81. Thus, the audio system of the present invention can output digital audio signals at each output 72, 81 thereby reducing the need to convert the digital data representing the captured audio back into analog form.

The manner in which the system 10 of the present invention is used will be described below with references to the Figures. Prior to the surfer 2 mounting the surfboard 4, the communication unit 18 is positioned and locked within the pocket 16 of the harness 12 using the locking device 17. The harness 12 is then positioned on the back of the user and the fastening devices 15 on each strap contact one another thereby securing the harness 12 to the surfer 12. The surfer 2 then mounts the board 4 and begins to surf. While surfing, the microphone 26 captures at least one of ambient sound and audible conversation from the surfer occurring within the predetermined distance thereof. The first processor 24 directs the transmitter 22 to transmit the audio signals 38 to the remote unit 30. The antenna 32 of the remote unit 30 causes the audio signals to be reproduced by the output device 36. As discussed above, the output device 36 causes the audio signals to be reproduced by speakers connected to the remote unit 30. Also, the output device 36 may cause the audio signals to be broadcast over at least one of a television, cable and satellite network. When the audio signals are being broadcasted, the audio signals can be matched with video data representing images of the surfer 2 surfing the wave 6. The video data is not part of this invention and will not be further discussed. Additionally, the output device 36 can distribute the audio signals across at least one of a telecommunication network and the Internet.

The system of the present invention provides viewers and listeners with additional insight into the sport of surfing. The ambient and conversational sound that is selectively captured by the system, which is then selectively broadcast and distributed over at least one of the television network, cable network, satellite network, communication network, and the Internet, allows for a more immersing viewing and listening experience. This system provides the additional entertainment benefit to viewers, listeners and fans of the sport of surfing while not disturbing the surfers in any way. The garment or harness used to retain the system to the surfer will not change the manner in which the surfer surfs. But, the system will provide additional entertainment value thereby potentially increasing the notoriety of the surfer as well the popularity of the sport.

While the above system is shown and described for use during surfing, the audio system 10 of the present invention is designed for use during any aquatic activity and/or sport. This includes but is not limited to jet skiing, water-skiing, wake-boarding, parasailing, wind-surfing, and swimming.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. An audio capture and transmission system for use during aquatic activity comprising:
a) means for capturing sound associated with an aquatic activity;
b) a harness for securing said system to a user, said harness housing said capturing means and including means for protecting said capturing means from the aquatic environment; and
c) means connected to said capturing means for transmitting a signal representative of said captured sound, whereby said transmitted signal is able to be received and combined with a corresponding video signal.

2. The system as recited in claim 1, further comprising a housing, said capturing means and said transmitting means being positioned in said housing and said housing is protected from the aquatic environment by said protecting means.

3. The system as recited in claim 2, wherein said housing is formed from a material that is at least one of waterproof, lightweight and durable so as to withstand a force associated with at least one of impact of waves in the aquatic environment, impact with a surface of a flotation device and impact with a surface of the water.

4. The system as recited in claim 2, wherein said housing is formed from material that is resistant to degradation caused by salt.

5. The system as recited in claim 2, wherein said capturing means is a microphone that is at least one of waterproof and resistant to damage caused by salt.

6. The system as recited in claim 5, wherein said transmitting means is a transmitter able to transmit at least one of an analog and digital signal.

7. The system as recited in claim 1, further comprising a housing having said transmitting means positioned therein.

8. The system as recited in claim 7, wherein said capturing means is positioned external to said housing and connected thereto by a wire.

9. The system as recited in claim 8, wherein said protection means protects each of said housing and said capturing means from the aquatic environment.

10. The system as recited in claim 2, wherein said harness is a garment worn on the torso of the user.

11. The system as recited in claim 11, wherein said protection means is a pocket positioned on an inner rear surface of said garment for receiving said housing therein.

12. The system as recited in claim 9, wherein said protection means comprises:
a) a pocket positioned on an inner rear surface of said harness for receiving said housing therein; and
b) a holding patch positioned on said harness for receiving and securing said capturing means therein, wherein said pocket and said holding patch protects said housing and said capturing means from the aquatic environment.

13. The system as recited in claim 1, wherein said aquatic activity includes at least one of surfing, waterskiing, water polo, swimming, wakeboarding, wind surfing, jet-skiing and parasailing.

14. An audio system for use during aquatic activity comprising:
a) means for capturing sound associated with an aquatic activity;
b) a harness for securing said system to a user, said harness housing said capturing means and said harness including means for protecting said capturing means from the aquatic environment;
c) means connected to said capturing means for transmitting a signal representative of said captured sound; and
d) a remote unit located remotely from said user for receiving said transmitted signal and selectively combining said transmitted signal with a corresponding video signal for broadcast over a network.

15. The system as recited in claim 14, wherein said remote unit further comprises a receiver able to receive at least one of analog and digital signal, wherein said receiver receives the same type of signals transmitted by said transmitter.

16. The system as recited in claim 14, wherein said network at least one of a television network, a cable network and a satellite network.

17. The system as recited in claim 14, wherein said remote unit further comprises means for distributing said received captured sound over at least one of a communication network and the Internet.

18. An audio communication system for use during aquatic activity comprising:
a) a first communication device for use by a first user, said first communication device comprising:
i. means for capturing sound of the first user while the first user is participating in an aquatic activity;
ii. a harness for securing said first communication device to the first user, said harness housing said capturing means including means for protecting said capturing means from the aquatic environment;
iii. means connected to said capturing means for transmitting a first signal representing said first users captured sound;
iv. means positioned within said harness for receiving a second sound signal;
v. means connected to said receiving means for audiblizing said second sound signal;
b) a second communication device for use by said second user, said second communication device comprising:
i. a mobile unit being positioned on a mobile aquatic craft;
ii. means worn by the second user for capturing sound from the second user;
iii. a transceiver positioned within said mobile unit and connected to said capturing means for transmitting the second signal representing said sound captured from said second user and for receiving said first signal; and
iv. means connected to said transceiver for audiblizing said first signal, thereby allowing said first and second users to communicate with one another during said aquatic activity.

19. The system as recited in claim 18, wherein the first user is positioned on a flotation device for towing by the second user on the mobile aquatic craft.

20. The system as recited in claim 18, wherein the mobile aquatic craft is a jet ski.
